(19) United States
(12) Patent Application Publication
(10) Pub. No.: US 2026/0097559 A1
(43) Pub. Date: Apr. 9, 2026

(54) Three-Dimensional Shaping Apparatus And Shaping Method

(71) Applicant: SEIKO EPSON CORPORATION, Tokyo (JP)

(72) Inventor: Junhua ZHANG, Shiojiri (JP)

(21) Appl. No.: 19/348,957

(22) Filed: Oct. 3, 2025

(30) Foreign Application Priority Data
Oct. 4, 2024 (JP) 2024-174869

(51) Int. Cl. B29C 64/321; B22F 10/22; B22F 10/85; B22F 12/53; B22F 12/90; B28B 1/00; B28B 17/00; B29C 64/118; B29C 64/209; B29C 64/393; B33Y 10/00; B33Y 40/00; B33Y 50/02

(52) U.S. Cl. CPC B29C 64/321; B22F 10/22; B22F 10/85; B22F 12/53; B22F 12/90; B28B 1/001; B28B 17/0081; B29C 64/118; B29C 64/209; B29C 64/393; B33Y 10/00; B33Y 40/00; B33Y 50/02

(57) ABSTRACT

According to an aspect of the present disclosure, there is provided a three-dimensional shaping apparatus including a first drive unit configured to move a first plunger in a first flow path, a second drive unit configured to move a second plunger in a second flow path, a switching unit configured to switch a first state in which the first flow path and a nozzle opening communicate and the first flow path and a plasticizing unit do not communicate and a second state in which the second flow path and the nozzle opening communicate and the second flow path and the plasticizing unit do not communicate, and a control unit. After causing the first drive unit to advance the first plunger to discharge a plasticized material from the nozzle opening in the first state, the control unit causes the second drive unit to advance the second plunger to discharge the plasticized material from the nozzle opening in the second state.

The present application is based on, and claims priority from JP Application Serial Number 2024-174869, filed Oct. 4, 2024, the disclosure of which is hereby incorporated by reference herein in its entirety.

### BACKGROUND

### 1. Technical Field

The present disclosure relates to a three-dimensional shaping apparatus and a shaping method.

### 2. Related Art

There is known a three-dimensional shaping apparatus that shapes a three-dimensional shaped object by discharging a plasticized material from a nozzle toward a stage and curing the plasticized material.

For example, JP-A-2023-182086 describes a three-dimensional shaping apparatus including a plasticizing unit that includes a screw and plasticizes a material to generate a shaping material, a nozzle that includes a nozzle opening and discharges the shaping material from the nozzle opening toward a stage, a discharge amount adjustment unit that adjusts a discharge amount of the shaping material from the nozzle opening, and a pressure adjustment unit that includes a plunger moving in a flow path.

JP-A-2023-182086 is an example of the related art.

In the three-dimensional shaping apparatus explained above, when pressure generated by the screw in the plasticizing unit fluctuates, it is likely that a line width of the shaping material discharged from the nozzle fluctuates because of the pressure fluctuation.

### SUMMARY

According to an aspect of the present disclosure, there is provided a three-dimensional shaping apparatus including:
a plasticizing unit configured to plasticize a material to generate a plasticized material;
a nozzle including a nozzle opening and configured to discharge the plasticized material from the nozzle opening;
a communication path configured to cause the plasticizing unit and the nozzle opening to communicate;
a first flow path and a second flow path coupled to the communication path;
a first plunger provided in the first flow path; a second plunger provided in the second flow path;
a first drive unit configured to move the first plunger in the first flow path;
a second drive unit configured to move the second plunger in the second flow path;
a switching unit configured to switch a first state in which the first flow path and the nozzle opening communicate and the first flow path and the plasticizing unit do not communicate and a second state in which the second flow path and the nozzle opening communicate and the second flow path and the plasticizing unit do not communicate; and
a control unit configured to control the plasticizing unit, the first drive unit, the second drive unit, and the switching unit, wherein
after causing the first drive unit to advance the first plunger to discharge the plasticized material from the nozzle opening in the first state, the control unit causes the second drive unit to advance the second plunger to discharge the plasticized material from the nozzle opening in the second state.

According to an aspect of the present disclosure, there is provided a shaping method of shaping a shaped object using a three-dimensional shaping apparatus including:
a plasticizing unit configured to plasticize a material to generate a plasticized material;
a nozzle including a nozzle opening and configured to discharge the plasticized material from the nozzle opening;
a communication path configured to cause the plasticizing unit and the nozzle opening to communicate;
a first flow path and a second flow path coupled to the communication path;
a first plunger provided in the first flow path;
a second plunger provided in the second flow path;
a first drive unit configured to move the first plunger in the first flow path;
a second drive unit configured to move the second plunger in the second flow path; and
a switching unit configured to switch a first state in which the first flow path and the nozzle opening communicate and the first flow path and the plasticizing unit do not communicate and a second state in which the second flow path and the nozzle opening communicate and the second flow path and the plasticizing unit do not communicate,
the shaping method including, after causing the first drive unit to advance the first plunger to discharge the plasticized material from the nozzle opening in the first state, causing the second drive unit to advance the second plunger to discharge the plasticized material from the nozzle opening in the second state.

### BRIEF DESCRIPTION OF THE DRAWINGS

FIG. 1 is a cross-sectional view schematically illustrating a three-dimensional shaping apparatus according to a first embodiment.

FIG. 2 is a perspective view schematically illustrating a flat screw of the three-dimensional shaping apparatus according to the first embodiment.

FIG. 3 is a plan view schematically illustrating a barrel of the three-dimensional shaping apparatus according to the first embodiment.

FIG. 4 is a flowchart illustrating an operation of the three-dimensional shaping apparatus according to the first embodiment.

FIG. 5 is a cross-sectional view schematically illustrating the three-dimensional shaping apparatus according to the first embodiment.

FIG. 6 is a cross-sectional view illustrating a shaping layer formed by the three-dimensional shaping apparatus according to the first embodiment.

FIG. 7 is a cross-sectional view schematically illustrating a three-dimensional shaping apparatus according to a modification of the first embodiment.

FIG. 8 is a flowchart illustrating an operation of a three-dimensional shaping apparatus according to the modification of the first embodiment.

FIG. 9 is a cross-sectional view schematically illustrating a three-dimensional shaping apparatus according to a second embodiment.

FIG. 10 is a cross-sectional view schematically illustrating the three-dimensional shaping apparatus according to the second embodiment.

FIG. 11 is a cross-sectional view schematically illustrating a three-dimensional shaping apparatus according to a third embodiment.

FIG. 12 is a cross-sectional view schematically illustrating the three-dimensional shaping apparatus according to the third embodiment.

### DESCRIPTION OF EMBODIMENTS

Preferred embodiments of the present disclosure are explained in detail below with reference to the drawings. Note that the embodiments explained below do not unreasonably limit content of the present disclosure described in the claims. Not all of components explained below are always essential elements of the present disclosure.

### 1. First Embodiment

### 1.1. Three-Dimensional Shaping Apparatus

### 1.1.1. Overall Configuration

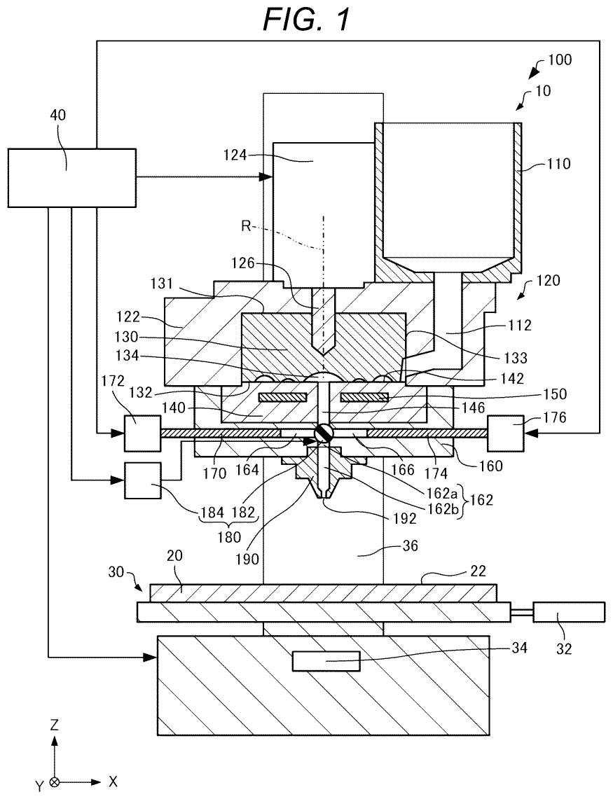

First, a three-dimensional shaping apparatus according to a first embodiment is explained with reference to the drawings. FIG. 1 is a cross-sectional view schematically illustrating a three-dimensional shaping apparatus 100 according to the first embodiment. FIG. 1 illustrates an X axis, a Y axis, and a Z axis as three axes orthogonal to one another. An X-axis direction and a Y-axis direction are, for example, the horizontal directions. A Z-axis direction is, for example, the vertical direction.

As illustrated in FIG. 1, the three-dimensional shaping apparatus 100 includes, for example, a discharging unit 10, a stage 20, a position changing unit 30, and a control unit 40.

While causing the discharging unit 10 to discharge a plasticized material toward the stage 20, the three-dimensional shaping apparatus 100 drives the position changing unit 30 to change relative positions of the discharging unit 10 and the stage 20. Accordingly, the three-dimensional shaping apparatus 100 shapes a three-dimensional shaped object having a desired shape on the stage 20. The three-dimensional shaping apparatus 100 is a three-dimensional shaping apparatus of a fused deposition modeling (FDM) (registered trademark) type.

Although not illustrated, a plurality of discharging units 10 may be provided. For example, two discharging units 10 may be provided. In this case, both of the two discharging units 10 may discharge the plasticized material configuring the three-dimensional shaped object or one may discharge the plasticized material and the other may discharge a support material that supports the three-dimensional shaped object. The two discharging units 10 may be aligned in the X-axis direction.

The discharging unit 10 includes, for example, a material storage unit 110, a plasticizing unit 120, a flow path forming unit 160, a first plunger 170, a first drive unit 172, a second plunger 174, a second drive unit 176, a switching unit 180, and a nozzle 190.

The material storage unit 110 stores a pellet-like or powder-like material. The material storage unit 110 supplies the material to the plasticizing unit 120. The material storage unit 110 includes, for example, a hopper. The material stored in the material storage unit 110 is, for example, acrylonitrile butadiene styrene (ABS) resin.

The material storage unit 110 and the plasticizing unit 120 are coupled by a supply path 112 provided below the material storage unit 110. The material put in the material storage unit 110 is supplied to the plasticizing unit 120 through the supply path 112.

The plasticizing unit 120 includes, for example, a screw case 122, a drive motor 124, a flat screw 130, a barrel 140, and a heating unit 150. The plasticizing unit 120 plasticizes a material in a solid state supplied from the material storage unit 110, generates a paste-like plasticized material having fluidity, and supplies the paste-like plasticized material to the nozzle 190.

Plasticizing is a concept including melting and means changing a solid state to a state having fluidity. Specifically, in the case of a material in which glass transition occurs, plasticizing means setting the temperature of the material to temperature equal to or higher than the glass transition point. In the case of a material in which glass transition does not occur, plasticizing means setting the temperature of the material to temperature equal to or higher than the melting point.

The screw case 122 is a housing that houses the flat screw 130. The barrel 140 is provided on the lower surface of the screw case 122. The flat screw 130 is housed in a space surrounded by the screw case 122 and the barrel 140.

The drive motor 124 is provided on an upper surface of the screw case 122. The drive motor 124 is, for example, a servo motor. A shaft 126 of the drive motor 124 is coupled to an upper surface 131 of the flat screw 130. The drive motor 124 is controlled by the control unit 40. Although not illustrated, the shaft 126 of the drive motor 124 and the upper surface 131 of the flat screw 130 may be coupled via a speed reducer.

The flat screw 130 has a substantially cylindrical shape, the size of which in a rotation axis R direction is smaller than size of which in a direction orthogonal to the rotation axis R direction. In the illustrated example, the rotation axis R is parallel to the Z axis. The flat screw 130 rotates centering on the rotation axis R with torque generated by the drive motor 124.

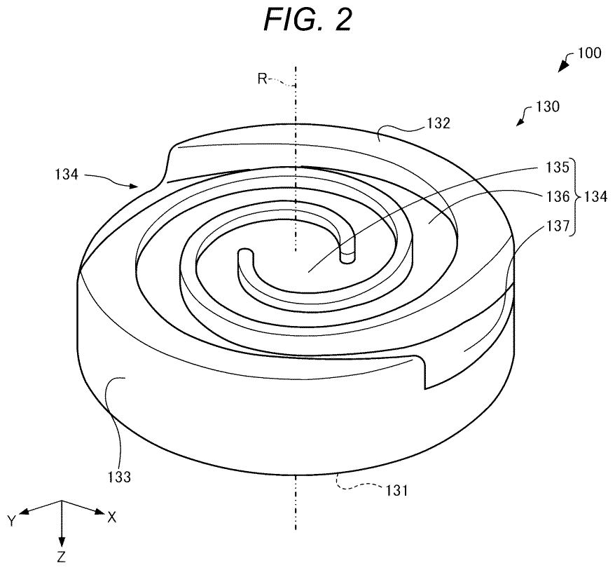

The flat screw 130 includes the upper surface 131, a groove forming surface 132 on the side opposite to the upper surface 131, and a side surface 133 that couples the upper surface 131 and the groove forming surface 132. A first groove 134 is formed on the groove forming surface 132. The side surface 133 is, for example, perpendicular to the groove forming surface 132. Here, FIG. 2 is a perspective view schematically illustrating the flat screw 130. For convenience, FIG. 2 illustrates a state in which an upper-lower positional relationship is reversed from a state illustrated in FIG. 1.

As illustrated in FIG. 2, the first groove 134 is formed on the groove forming surface 132 of the flat screw 130. The first groove 134 includes, for example, a central section 135, a coupling section 136, and a material introduction section 137. The central section 135 faces a communication hole 146 formed in the barrel 140. The central section 135 communicates with the communication hole 146. The coupling section 136 couples the central section 135 and the material introduction section 137. In the illustrated example, the coupling section 136 is provided in a spiral shape from the central section 135 toward the outer circumference of the groove forming surface 132. The material introduction section 137 is provided on the outer circumference of the groove forming surface 132. That is, the material introduction section 137 is provided on the side surface 133 of the flat screw 130. The material supplied from the material storage unit 110 is introduced from the material introduction section 137 into the first groove 134, passes through the coupling section 136 and the central section 135, and is conveyed to the communication hole 146 formed in the barrel 140. For example, two first grooves 134 are provided.

The number of first grooves 134 is not particularly limited. Although not illustrated, three or more first grooves 134 may be formed or only one first groove 134 may be formed.

Although not illustrated, the plasticizing unit 120 may include, rather than the flat screw 130, an elongated in-line screw including a spiral groove on a side surface thereof. The plasticizing unit 120 may plasticize a material according to rotation of the in-line screw. However, when a reduction in the size of the apparatus is considered, it is preferable to use the flat screw 130.

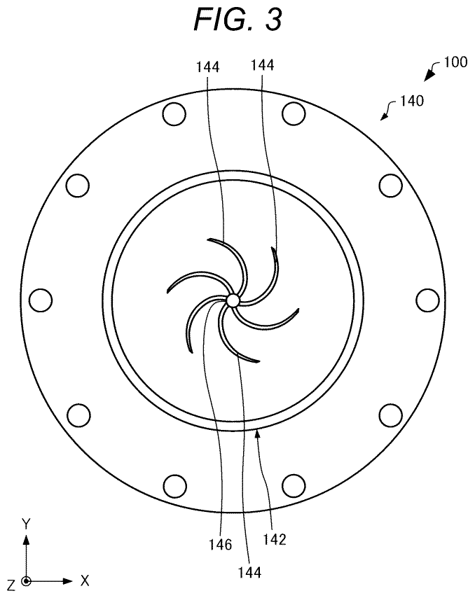

As illustrated in FIG. 1, the barrel 140 is provided below the flat screw 130. The barrel 140 includes a facing surface 142 facing the groove forming surface 132 of the flat screw 130. The communication hole 146 communicating with the first groove 134 is formed in the center of the facing surface 142. Here, FIG. 3 is a plan view schematically illustrating the barrel 140.

As illustrated in FIG. 3, a second groove 144 and the communication hole 146 are formed on the facing surface 142 of the barrel 140. A plurality of second grooves 144 are formed. In the illustrated example, six second grooves 144 are formed. However, the number of second grooves 144 is not particularly limited. The plurality of second grooves 144 are formed around the communication hole 146 when viewed in the Z-axis direction. One end of the second groove 144 is coupled to the communication hole 146 and extends spirally from the communication hole 146 toward the outer circumference of the barrel 140. The second grooves 144 have a function of guiding a plasticized material to the communication hole 146.

The shape of the second groove 144 is not particularly limited and may be, for example, a linear shape. One end of the second groove 144 may not be coupled to the communication hole 146. Further, the second groove 144 may not be formed on the facing surface 142. However, efficiently guiding a plasticized material to the communication hole 146 is considered, the second groove 144 is preferably formed on the facing surface 142.

As illustrated in FIG. 1, the heating unit 150 is provided in the barrel 140. The heating unit 150 is a heater. The heating unit 150 is, for example, a rod heater. The heating unit 150 heats a material supplied to between the flat screw 130 and the barrel 140. Output of the heating unit 150 is controlled by the control unit 40. While conveying the material toward the communication hole 146 with the flat screw 130, the barrel 140, and the heating unit 150, the plasticizing unit 120 heats the material to generate a plasticized material. Then, the plasticizing unit 120 causes the generated plasticized material to flow out from the communication hole 146. The shape of the heating unit 150 may be a ring shape when viewed in the Z-axis direction.

The flow path forming unit 160 is provided below the barrel 140. A communication path 162, a first flow path 164, and a second flow path 166 are formed in the flow path forming unit 160. The flow path forming unit 160 defines the communication path 162, the first flow path 164, and the second flow path 166.

The communication path 162 causes the plasticizing unit 120 and the nozzle 190 to communicate. In the illustrated example, the communication path 162 causes the communication hole 146 of the barrel 140 of the plasticizing unit 120 and the nozzle opening 192 of the nozzle 190 to communicate. The communication path 162 includes, for example, a first portion 162a formed in the flow path forming unit 160 and a second portion 162b formed in the nozzle 190. In the illustrated example, the communication path 162 extends in a −Z-axis direction from the communication hole 146 toward the nozzle opening 192.

The first flow path 164 and the second flow path 166 are coupled to the communication path 162. In the illustrated example, the first flow path 164 extends in a −X-axis direction from the communication path 162. The second flow path 166 extends in a +X-axis direction from the communication path 162. The first flow path 164 and the second flow path 166 are provided at the same position in the Z-axis direction. A plasticized material flows in the first flow path 164, the second flow path 166, and the communication path 162.

The first plunger 170 is provided in the first flow path 164. The first plunger 170 moves in the first flow path 164. In the illustrated example, the first plunger 170 moves in ±X-axis directions. The flow path forming unit 160 may include a first cylinder. The first plunger 170 may move in the first cylinder. The first drive unit 172 drives the first plunger 170. The first drive unit 172 moves the first plunger 170 in the first flow path 164.

The second plunger 174 is provided in the second flow path 166. The second plunger 174 moves in the second flow path 166. In the illustrated example, the second plunger 174 moves in the ±X-axis directions. The flow path forming unit 160 may include a second cylinder. The second plunger 174 may move in the second cylinder. The second drive unit 176 drives the second plunger 174. The second drive unit 176 moves the second plunger 174 in the second flow path 166. The drive units 172 and 176 are, for example, motors. More specifically, the drive units 172 and 176 are servo motors. The drive units 172 and 176 are controlled by the control unit 40.

The switching unit 180 includes a valve 182 and a rotation drive unit 184. The valve 182 is provided in the communication path 162. In the illustrated example, the valve 182 is provided in a coupling section of the communication path 162 and the first flow path 164 and at a coupling section of the communication path 162 and the second flow path 166. The rotation drive unit 184 rotates the valve 182. In the illustrated example, the rotation drive unit 184 rotates the valve 182 around an axis parallel to the Y axis. The rotation drive unit 184 includes, for example, a motor. The rotation drive unit 184 is controlled by the control unit 40. The rotation drive unit 184 rotates the valve 182, whereby the switching unit 180 switches a first state in which the first flow path 164 and the nozzle opening 192 communicate and the first flow path 164 and the plasticizing unit 120 do not communicate and a second state in which the second flow path 166 and the nozzle opening 192 communicate and the second flow path 166 and the plasticizing unit 120 do not communicate.

The nozzle 190 is provided below the flow path forming unit 160. The second portion 162b of the communication path 162 is formed in the nozzle 190. The nozzle 190 includes a nozzle opening 192. The nozzle opening 192 is provided at the distal end of the communication path 162. The nozzle 190 discharges a plasticized material, which flows in the communication path 162, from the nozzle opening 192 toward the stage 20.

The stage 20 is provided below the nozzle 190. In the illustrated example, the shape of the stage 20 is a rectangular parallelepiped. The stage 20 includes a deposition surface 22 on which the plasticized material is deposited. The deposition surface 22 is a region of the upper surface of the stage 20. The material of the stage 20 is metal such as aluminum.

The position changing unit 30 supports the stage 20. The position changing unit 30 changes the relative positions of the discharging unit 10 and the stage 20. In the illustrated example, the position changing unit 30 moves the stage 20 in the X-axis direction and the Y-axis direction to thereby change relative positions of the nozzle 190 and the stage 20 in the X-axis direction and the Y-axis direction. Further, the position changing unit 30 moves the discharging unit 10 in the Z-axis direction to thereby change the relative positions of the nozzle 190 and the stage 20 in the Z-axis direction.

The position changing unit 30 includes, for example, a first electric actuator 32, a second electric actuator 34, and a third electric actuator 36. The first electric actuator 32 moves the stage 20 in the X-axis direction. The second electric actuator 34 moves the stage 20 in the Y-axis direction. The third electric actuator 36 moves the discharging unit 10 in the Z-axis direction.

A configuration of the position changing unit 30 is not particularly limited if the relative positions of the discharging unit 10 and the stage 20 can be changed. For example, the position changing unit 30 may be configured to move the stage 20 in the Z-axis direction and move the discharging unit 10 in the X-axis direction and the Y-axis direction. The position changing unit 30 may be configured to move the stage 20 or the discharging unit 10 in the X-axis direction, the Y-axis direction, and the Z-axis direction.

The control unit 40 includes, for example, a computer including a processor, a main storage device, and an input/output interface for receiving input of a signal from and outputting a signal to the outside. The processor executes programs read in the main storage device, whereby the control unit 40 exerts various functions. The control unit 40 controls the discharging unit 10 and the position changing unit 30. Specifically, the control unit 40 controls the drive motor 124, the heating unit 150, the first drive unit 172, the second drive unit 176, the rotation drive unit 184, and the electric actuators 32, 34, and 36. The control unit 40 may include a combination of a plurality of circuits rather than the computer.

### 1.1.2. Operation

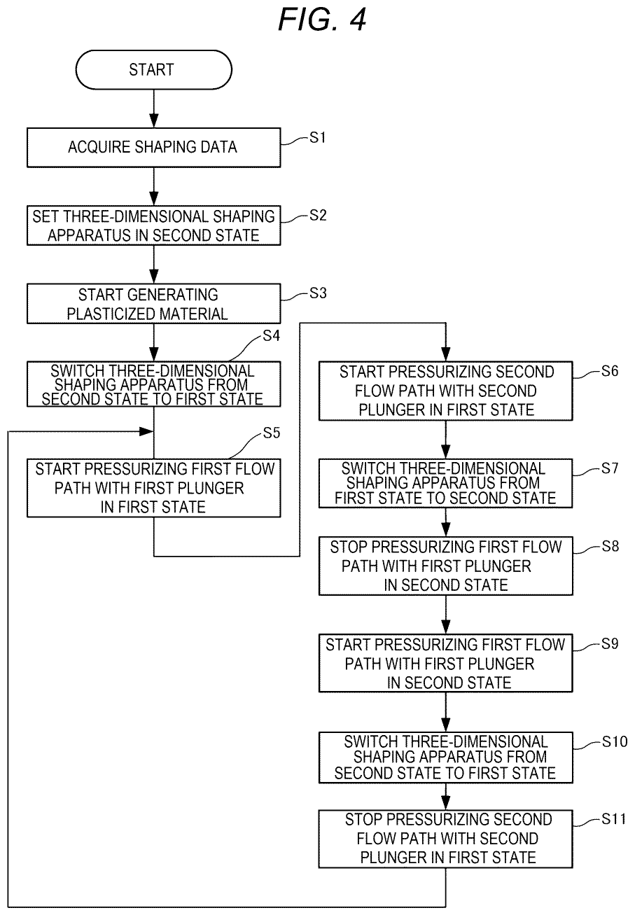

FIG. 4 is a flowchart illustrating an operation of the three-dimensional shaping apparatus 100. Specifically, FIG. 4 is a flowchart illustrating processing of the control unit 40 of the three-dimensional shaping apparatus 100.

For example, a user operates a not-illustrated operation unit to output, to the control unit 40, a processing start signal for starting processing. The operation unit includes, for example, a mouse, a keyboard, or a touch panel. When receiving the processing start signal, the control unit 40 starts the processing.

First, as illustrated in FIG. 4, in step S1, the control unit 40 performs processing of acquiring shaping data for shaping a three-dimensional shaped object.

The shaping data includes information concerning, for example, a type of a material stored in the material storage unit 110, a movement path of the discharging unit 10 with respect to the stage 20, an amount of a plasticized material discharged from the discharging unit 10.

The shaping data is created by, for example, causing slicer software installed in a computer coupled to the three-dimensional shaping apparatus 100 to read shape data. The shape data is data representing a target shape of a three-dimensional shaped object created using three-dimensional computer aided design (CAD) software, three-dimensional computer graphics (CG) software, or the like. As the shape data, for example, data such as data in a standard triangulated language (STL) format or an additive manufacturing file format (AMF) is used. The slicer software divides the target shape of the three-dimensional shaped object into layers having predetermined thicknesses and creates shaping data for each of the layers. The shaping data is represented by a G code, an M code, or the like. The control unit 40 acquires shaping data from a computer coupled to the three-dimensional shaping apparatus 100 or a recording medium such as a universal serial bus (USB) memory.

Subsequently, as step S2, the control unit 40 performs processing of setting the three-dimensional shaping apparatus 100 to the second state in which the second flow path 166 and the nozzle opening 192 communicate and the second flow path 166 and the plasticizing unit 120 do not communicate. In the second state, the second flow path 166 and the plasticizing unit 120 communicate. When the three-dimensional shaping apparatus 100 is in the first state after the processing in step S1 ends, the control unit 40 controls the switching unit 180 to switch the three-dimensional shaping apparatus 100 from the first state to the second state. When the three-dimensional shaping apparatus 100 is in the second state after the processing in step S1 ends, the control unit 40 may shift to step S3 without controlling the switching unit 180.

Subsequently, as step S3, the control unit 40 performs processing of controlling the drive motor 124 to rotate the flat screw 130 and controlling the heating unit 150 to plasticize a supplied material to generate a plasticized material. The plasticized material is generated until the processing of the control unit 40 ends.

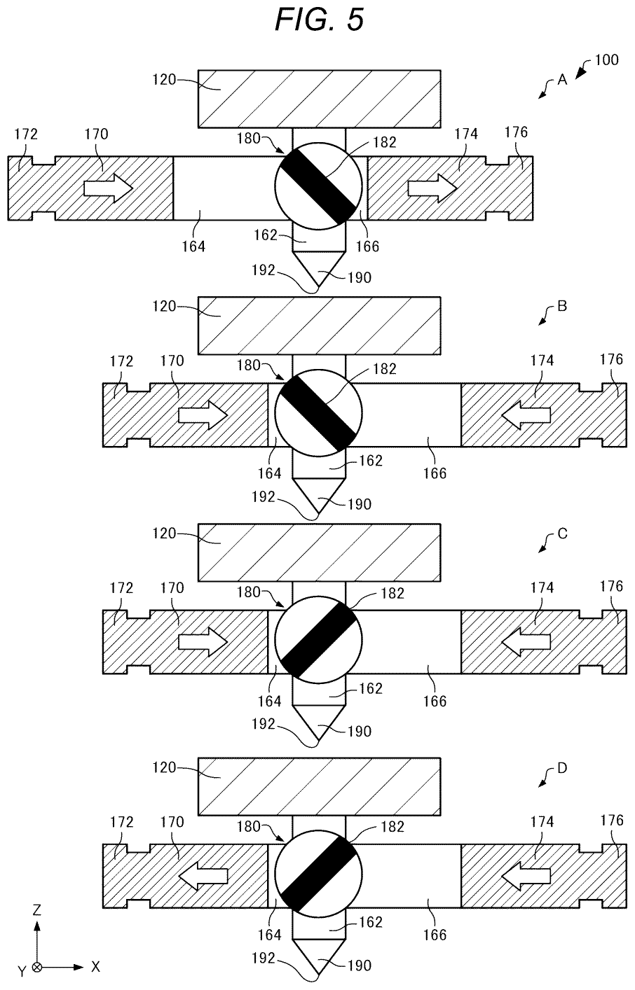

Here, FIG. 5 is a cross-sectional view schematically illustrating the three-dimensional shaping apparatus 100 and is a cross-sectional view illustrating operations of the first plunger 170, the second plunger 174, and the valve 182. For convenience, in FIG. 5, the plasticizing unit 120, the plungers 170 and 174, the drive units 172 and 176, and the nozzle 190 are simplified and illustrated. In FIG. 5, members other than the plasticizing unit 120, the communication path 162, the flow paths 164 and 166, the plungers 170 and 174, the drive units 172 and 176, the valve 182, and the nozzle 190 are not illustrated.

As step S4, as indicated by A in FIG. 5, the control unit 40 performs processing of controlling the switching unit 180 to switch the three-dimensional shaping apparatus 100 from the second state to the first state in which the first flow path 164 and the nozzle opening 192 communicate and the first flow path 164 and the plasticizing unit 120 do not communicate. Specifically, the control unit 40 controls the rotation drive unit 184 to rotate the valve 182 to switch the three-dimensional shaping apparatus 100 from the second state to the first state. For example, when a predetermined time has elapsed after performing the processing in step S3, the control unit 40 performs the processing in step S4.

Subsequently, as step S5, as indicated by A in FIG. 5, the control unit 40 performs processing of, in the first state, controlling the first drive unit 172 to cause the first plunger 170 to pressurize the first flow path 164. The first plunger 170 pressurizes the first flow path 164 until the control unit 40 performs processing in step S8 explained below. For example, when a predetermined time has elapsed after performing the processing in step S4, the control unit 40 performs the processing in step S5.

According to the processing in step S5, the first plunger 170 advances in the first flow path 164. The plasticized material is discharged from the nozzle opening 192 by the advance of the first plunger 170.

Here, the plungers 170 and 174 moving in the direction approaching the communication path 162 is referred to as “advance” and the plungers 170 and 174 moving in the direction away from the communication path 162 is referred to as “retreat”. In the illustrated example, “the first plunger 170 advances” means that the first plunger 170 moves in the +X-axis direction and “the first plunger 170 retreats” means that the first plunger 170 moves in the −X-axis direction. “The second plunger 174 advances” means that the second plunger 174 moves in the −X-axis direction and “the second plunger 174 retreats” means that the second plunger 174 moves in the +X-axis direction.

While the first plunger 170 is advancing by being driven by the first drive unit 172, the control unit 40 may control the first drive unit 172 such that the torque of the first drive unit 172 is constant. For example, when the torque of the first drive unit 172 is larger than a predetermined value, the control unit 40 controls the first drive unit 172 to reduce the torque to be a predetermined value. Conversely, when the torque of the first drive unit 172 is smaller than the predetermined value, the control unit 40 controls the first drive unit 172 to increase the torque to be the predetermined value.

While the first plunger 170 is advancing by being driven by the first drive unit 172, the control unit 40 may control the first drive unit 172 such that the rotation speed of the first drive unit 172 is constant. For example, when the rotation speed of the first drive unit 172 is larger than a predetermined value, the control unit 40 controls the first drive unit 172 so as to reduce the rotation speed to be the predetermined value. Conversely, when the rotation speed of the first drive unit 172 is smaller than the predetermined value, the control unit 40 controls the first drive unit 172 to increase the rotation speed to be the predetermined value.

When the temperature of the plasticized material does not change, the rotation speed of the first drive unit 172 can be controlled to be constant if the torque of the first drive unit 172 is controlled to be constant. If the rotation speed of the first drive unit 172 is controlled to be constant, the torque of the first drive unit 172 can be controlled to be constant. The same applies to the second drive unit 176.

When the first plunger 170 is advancing in the first state according to the processing in step S5, the second plunger 174 retreats. In the illustrated example, in the first state, the second flow path 166 and the plasticizing unit 120 communicate and the second flow path 166 and the nozzle opening 192 do not communicate. For that reason, the second plunger 174 retreats, whereby the second flow path 166 is filled with the plasticized material. The second plunger 174 may retreat with pressure generated by the rotation of the flat screw 130 of the plasticizing unit 120 or may retreat with the control unit 40 controlling the second drive unit 176.

Subsequently, as step S6, as indicated by B in FIG. 5, the control unit 40 performs processing of, in the first state, controlling the second drive unit 176 to cause the second plunger 174 to pressurize the second flow path 166. The second plunger 174 pressurizes the second flow path 166 until the control unit 40 performs processing in step S11 explained below. For example, when a predetermined time has elapsed after performing the processing in step S5, the control unit 40 performs the processing in step S6.

The second plunger 174 is pushed in the +X-axis direction by pressure generated by the flat screw 130 of the plasticizing unit 120. When, according to the processing in step S6, a force (a plunger pressing force) pressing the second plunger 174 in the −X-axis direction is larger than a force (a screw pressing force) pressing the second plunger 174 in the +X-axis direction by the flat screw 130, the second plunger 174 moves in the −X-axis direction according to the processing in step S6. When the plunger pressing force is the same as the screw pressing force, the second plunger 174 stops according to the processing in step S6. When the plunger pressing force is smaller than the screw pressing force, the second plunger 174 moves in the +X-axis direction. While the second flow path 166 is pressurized according to the processing in step S6, the first flow path 164 is pressurized by the first plunger 170.

Next, as step S7, as indicated by C in FIG. 5, the control unit 40 controls the switching unit 180 to perform processing of switching the three-dimensional shaping apparatus 100 from the first state to the second state in which the second flow path 166 and the nozzle opening 192 communicate and the second flow path 166 and the plasticizing unit 120 do not communicate.

Specifically, the control unit 40 controls the rotation drive unit 184 to rotate the valve 182 to switch the three-dimensional shaping apparatus 100 from the first state to the second state. In an example indicated by C in FIG. 5, in the second state, the first flow path 164 communicates with the plasticizing unit 120 and does not communicate with the nozzle opening 192. For example, when a predetermined time has elapsed after performing the processing in step S6, the control unit 40 performs the processing in step S7.

According to the processing in steps S6 and S7, the second plunger 174 advances in the second flow path 166. The plasticized material is discharged from the nozzle opening 192 by the advance of the second plunger 174.

While the second plunger 174 is advancing by being driven by the second drive unit 176, as in the processing in step S5 explained above, the control unit 40 may control the second drive unit 176 such that the torque of the second drive unit 176 is constant or may control the second drive unit 176 such that the rotation speed of the second drive unit 176 is constant.

Subsequently, as step S8, as indicated by D in FIG. 5, the control unit 40 controls the first drive unit 172 to perform processing of stopping the pressurization of the first flow path 164 by the first drive unit 172. For example, when a predetermined time has elapsed after performing the processing in step S7, the control unit 40 performs the processing in step S8.

According to the processing in step S8, the first plunger 170 retreats. That is, when the second plunger 174 is advancing, the first plunger 170 retreats. In the illustrated example, in the second state, the first flow path 164 and the plasticizing unit 120 communicate and the first flow path 164 and the nozzle opening 192 do not communicate. For that reason, the first plunger 170 retreats, whereby the first flow path 164 is filled with the plasticized material. As in the retreat of the second plunger 174 explained above, the first plunger 170 may retreat with pressure generated by the rotation of the flat screw 130 of the plasticizing unit 120 or may retreat with the control unit 40 controlling the first drive unit 172.

Subsequently, as step S9, the control unit 40 performs processing of, in the second state, controlling the first drive unit 172 to cause the first plunger 170 to pressurize the first flow path 164. For example, when a predetermined time has elapsed after performing the processing in step S8, the control unit 40 performs the processing in step S9.

Subsequently, as step S10, the control unit 40 performs processing of controlling the switching unit 180 to switch the three-dimensional shaping apparatus 100 from the second state to the first state in which the first flow path 164 and the nozzle opening 192 communicate and the first flow path 164 and the plasticizing unit 120 do not communicate. For example, when a predetermined time has elapsed after performing the processing in step S9, the control unit 40 performs the processing in step S10.

Subsequently, as step S11, the control unit 40 performs processing of, in the second state, controlling the second drive unit 176 to stop the pressurization on the second flow path 166 by the second drive unit 176. For example, when a predetermined time has elapsed after performing the processing in step S10, the control unit 40 performs the processing in step S11.

By repeating the processing in steps S5 to S11 explained above, the control unit 40 can continuously discharge the plasticized material from the nozzle opening 192.

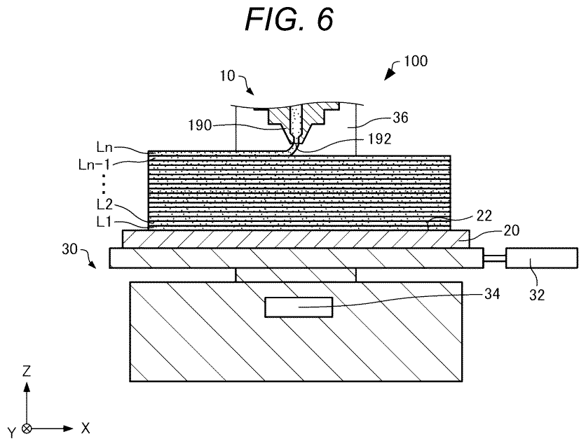

Here, FIG. 6 is a cross-sectional view illustrating a shaping layer formed on the stage 20 by the plasticized material discharged from the nozzle 190.

As illustrated in FIG. 6, based on the acquired shaping data, while controlling the position changing unit 30 to change relative positions of the discharging unit 10 and the stage 20, the control unit 40 controls the discharging unit 10 to discharge the plasticized material from the nozzle 190 toward the stage 20.

Specifically, before formation of a shaping layer L1, which is a first shaping layer, is started, the nozzle 190 is disposed at an initial position further in the −X axis direction than the end portion in the −X axis direction of the stage 20. When the processing in step S5 is started, as illustrated in FIG. 6, the control unit 40 controls the position changing unit 30 to, for example, relatively move the nozzle 190 in the +X-axis direction with respect to the stage 20. When the nozzle 190 passes over the stage 20, the plasticized material is discharged from the nozzle 190. Accordingly, the shaping layer L1 is formed. In FIG. 6, shaping layers up to an n-th shaping layer Ln are illustrated, where n is any natural number.

Subsequently, the control unit 40 performs determination processing of determining, based on the shaping data, whether the formation of all the shaping layers has been completed. Specifically, while repeating the processing in steps S5 to S11, the control unit 40 determines, based on the shaping data, whether the formation of all the shaping layers has been completed. After the end of the processing in steps S5 to S11, the control unit 40 may determine, based on the shaping data, whether the formation of all the shaping layers is completed.

When determining that the formation of all the shaping layers has not been completed, the control unit 40 continuously repeats the processing in steps S5 to S11 until the control unit 40 determines that the formation of all the shaping layers has been completed. On the other hand, when determining that the formation of all the shaping layers has been completed, the control unit 40 ends the processing.

### 1.1.3. Action Effects

The three-dimensional shaping apparatus 100 includes the plasticizing unit 120 that plasticizes a material to generate a plasticized material, the nozzle 190 that includes the nozzle opening 192 and discharges the plasticized material from the nozzle opening 192, the communication path 162 that communicates the plasticizing unit 120 with the nozzle opening 192, the first flow path 164 and the second flow path 166 coupled to the communication path 162, the first plunger 170 provided in the first flow path 164, the second plunger 174 provided in the second flow path 166, the first drive unit 172 that moves the first plunger 170 in the first flow path 164, and the second drive unit 176 that moves the second plunger 174 in the second flow path 166. The three-dimensional shaping apparatus 100 further includes the switching unit 180 that switches the first state in which the first flow path 164 and the nozzle opening 192 communicate and the first flow path 164 and the plasticizing unit 120 do not communicate and the second state in which the second flow path 166 and the nozzle opening 192 communicate and the second flow path 166 and the plasticizing unit 120 do not communicate. The three-dimensional shaping apparatus 100 further includes the control unit 40 that controls the plasticizing unit 120, the first drive unit 172, the second drive unit 176, and the switching unit 180. In the first state, after causing the first drive unit 172 to advance the first plunger 170 to discharge the plasticized material from the nozzle opening 192, in the second state, the control unit 40 causes the second drive unit 176 to advance the second plunger 174 to discharge the plasticized material from the nozzle opening 192.

As explained above, in the three-dimensional shaping apparatus 100, since the plasticized material in the first flow path 164 can be discharged in a state in which the first flow path 164 and the plasticizing unit 120 do not communicate, even when pressure fluctuation occurs in the plasticizing unit 120, it is possible to stabilize the pressure in the first flow path 164. Further, since the plasticized material in the second flow path 166 can be discharged in a state in which the second flow path 166 and the plasticizing unit 120 do not communicate, even when pressure fluctuation occurs in the plasticizing unit 120, it is possible to stabilize the pressure in the second flow path 166. Accordingly, it is possible to stabilize the line width of the plasticized material discharged from the nozzle opening 192 and it is possible to reduce the likelihood of the line width of the plasticized material fluctuating. Therefore, it is possible to accurately control the line width of the plasticized material discharged from the nozzle opening 192.

In the three-dimensional shaping apparatus 100, in the first state, the second flow path 166 and the plasticizing unit 120 communicate and the second flow path 166 and the nozzle opening 192 do not communicate and, when the first plunger 170 is advancing in the first state, the second plunger 174 retreats and, in the second state, the first flow path 164 and the plasticizing unit 120 communicate and the first flow path 164 and the nozzle opening 192 do not communicate and, when the second plunger 174 is advancing in the second state, the first plunger 170 retreats. For that reason, in the three-dimensional shaping apparatus 100, the second flow path 166 can be filled with the plasticized material in the first state and the first flow path 164 can be filled with the plasticized material in the second state. Accordingly, it is possible to alternately discharge, from the nozzle opening 192, the plasticized material filled in the first flow path 164 and the plasticized material filled in the second flow path 166.

In the three-dimensional shaping apparatus 100, while the three-dimensional shaping apparatus 100 is switched from the first state to the second state by the switching unit 180, the first flow path 164 is pressurized by the first plunger 170 and the second flow path 166 is pressurized by the second plunger 174. For that reason, in the three-dimensional shaping apparatus 100, even when the plasticizing unit 120 and the nozzle opening 192 are temporarily caused to communicate while the three-dimensional shaping apparatus 100 is switched from the first state to the second state, the pressure in the first flow path 164 and the pressure in the second flow path 166 can be stabilized. Accordingly, it is possible to stabilize a discharge amount of the plasticized material discharged from the nozzle opening 192.

In the three-dimensional shaping apparatus 100, the first drive unit 172 and the second drive unit 176 are the motors and, while the first plunger 170 is advanced by the first drive unit 172, the control unit 40 controls the first drive unit 172 such that the torque of the first drive unit 172 is constant and, while the second plunger 174 is advanced by the second drive unit 176, the control unit 40 controls the second drive unit 176 such that the torque of the second drive unit 176 is constant. For that reason, in the three-dimensional shaping apparatus 100, it is possible to reduce fluctuation in the pressure in the first flow path 164 and fluctuation in the pressure in the second flow path 166.

In the three-dimensional shaping apparatus 100, the first drive unit 172 and the second drive unit 176 are the motors and, while the first plunger 170 is advanced by the first drive unit 172, the control unit 40 controls the first drive unit 172 such that the rotation speed of the first drive unit 172 is constant and, while the second plunger 174 is advanced by the second drive unit 176, the control unit 40 controls the second drive unit 176 such that the rotation speed of the second drive unit 176 is constant. For that reason, in the three-dimensional shaping apparatus 100, even when the viscosity of the plasticized material fluctuates because temperature fluctuates, it is possible to stabilize a discharge amount of the plasticized material discharged from the nozzle opening 192.

### 1.2. Modification of the Three-dimensional Shaping Apparatus

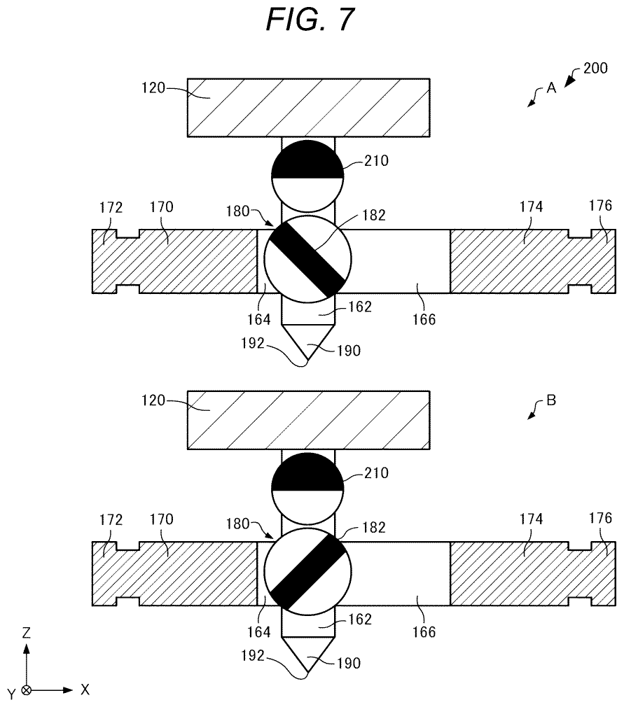

Subsequently, a three-dimensional shaping apparatus according to a modification of the first embodiment is explained with reference to the drawings. FIG. 7 is a cross-sectional view schematically illustrating a three-dimensional shaping apparatus 200 according to the modification of the first embodiment. For convenience, in FIG. 7, the plasticizing unit 120, the plungers 170 and 174, the drive units 172 and 176, and the nozzle 190 are simplified and illustrated. In FIG. 7, members other than the plasticizing unit 120, the communication path 162, the flow paths 164 and 166, the plungers 170 and 174, the drive units 172 and 176, the valve 182, the nozzle 190, and an upstream valve 210 are not illustrated.

Hereinafter, in the three-dimensional shaping apparatus 200 according to the modification of the first embodiment, members having the same functions as the functions of the constituent members of the three-dimensional shaping apparatus 100 according to the first embodiment explained above are denoted by the same reference numerals and signs and detailed explanation of the members is omitted.

As illustrated in FIG. 7, the three-dimensional shaping apparatus 200 is different from the three-dimensional shaping apparatus 100 explained above in that the three-dimensional shaping apparatus 200 includes the upstream valve 210. A in FIG. 7 indicates the first state. B in FIG. 7 indicates the second state.

The upstream valve 210 is provided in the communication path 162. The upstream valve 210 is provided further upstream than the valve 182 of the switching unit 180. In the illustrated example, the upstream valve 210 is provided between the plasticizing unit 120 and the valve 182. The upstream valve 210 is, for example, a butterfly valve.

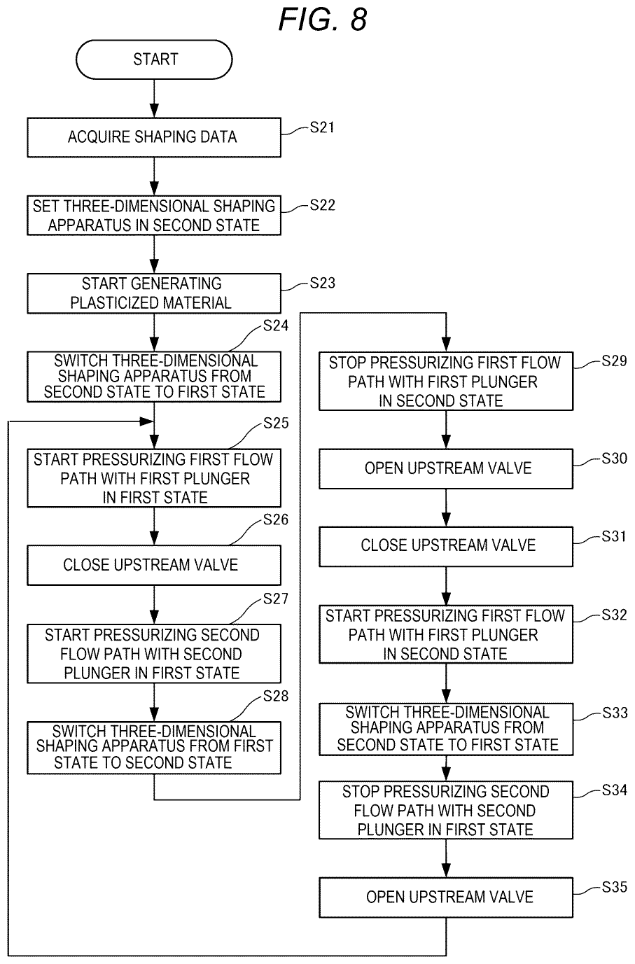

FIG. 8 is a flowchart illustrating an operation of the three-dimensional shaping apparatus 200. Specifically, FIG. 8 is a flowchart illustrating processing of the control unit 40 of the three-dimensional shaping apparatus 200.

In FIG. 8, kinds of processing in steps S21 to S25 are respectively basically the same as the kinds of processing in steps S1 to S5 of the three-dimensional shaping apparatus 100 explained above.

After the processing in step S25 ends, as step S26, the control unit 40 of the three-dimensional shaping apparatus 200 performs processing of closing the upstream valve 210. Accordingly, the first flow path 164 and the plasticizing unit 120 do not communicate and the second flow path 166 and the plasticizing unit 120 do not communicate. When the processing in step S25 is performed, the upstream valve 210 is opened.

In FIG. 8, kinds of processing in steps S27 to S29 are respectively basically the same as the kinds of processing in steps S6 to S8 of the three-dimensional shaping apparatus 100 explained above.

After the processing in step S29 ends, as step S30, the control unit 40 of the three-dimensional shaping apparatus 200 performs processing of opening the upstream valve 210. Accordingly, the first flow path 164 and the plasticizing unit 120 communicate and the first flow path 164 is filled with the plasticized material.

Subsequently, as step S31, the control unit 40 performs processing of closing the upstream valve 210. Accordingly, the first flow path 164 and the plasticizing unit 120 do not communicate and the second flow path 166 and the plasticizing unit 120 do not communicate. For example, when a predetermined time has elapsed after performing the processing in step S30, the control unit 40 performs the processing in step S31.

In FIG. 8, kinds of processing in steps S32 to S34 are respectively basically the same as the kinds of processing in steps S9 to S11 of the three-dimensional shaping apparatus 100 explained above.

After the processing in step S34 ends, as step S35, the control unit 40 of the three-dimensional shaping apparatus 200 performs processing of opening the upstream valve 210. Accordingly, the second flow path 166 and the plasticizing unit 120 communicate and the second flow path 166 is filled with the plasticized material.

Subsequently, the control unit 40 performs determination processing of determining, based on the shaping data, whether the formation of all the shaping layers has been completed. Specifically, while repeating the processing in steps S25 to S35, the control unit 40 determines, based on the shaping data, whether the formation of all the shaping layers has been completed. After the end of the processing in steps S25 to S35, the control unit 40 may determine, based on the shaping data, whether the formation of all the shaping layers has been completed.

When determining that the formation of all the shaping layers has not been completed, the control unit 40 continuously repeats the processing in steps S25 to S35 until the control unit 40 determines that the formation of all the shaping layers has been completed. On the other hand, when determining that the formation of all the shaping layers has been completed, the control unit 40 ends the processing.

In the three-dimensional shaping apparatus 200, the switching unit 180 includes the valve 182 provided in the communication path 162, the three-dimensional shaping apparatus 200 includes the upstream valve 210 provided in the communication path 162 and located further upstream than the valve 182, and the control unit 40 closes the upstream valve 210 after the plasticized material is discharged in the first state and before the three-dimensional shaping apparatus 200 is switched from the first state to the second state by the switching unit 180. For that reason, in the three-dimensional shaping apparatus 200, even when the second flow path 166 is pressurized by the second plunger 174 while the three-dimensional shaping apparatus 200 is switched from the first state to the second state, it is possible to prevent the plasticized material in the second flow path 166 from flowing back to the plasticizing unit 120.

### 2. Second Embodiment

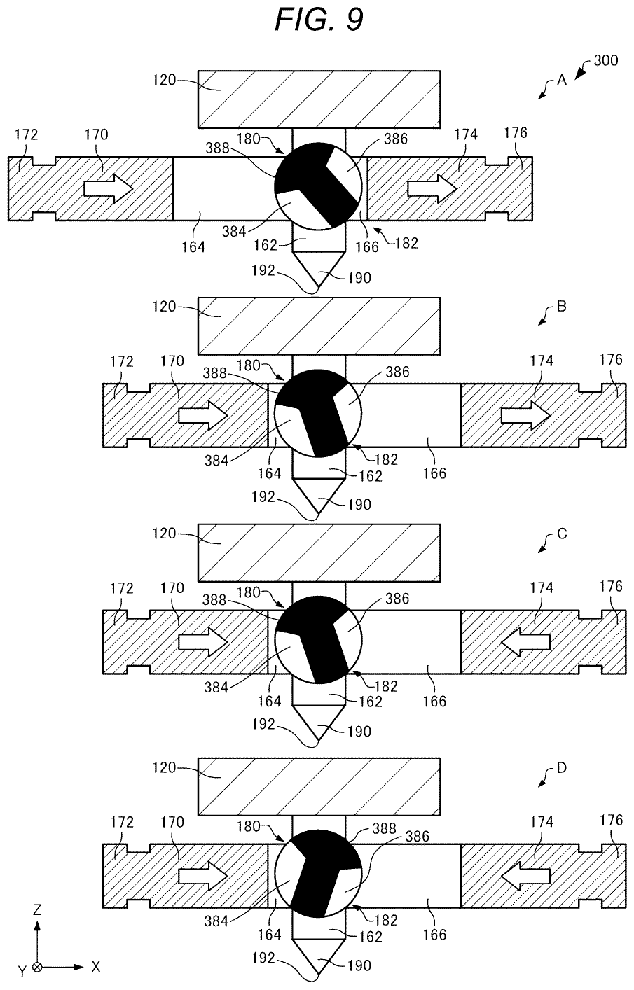

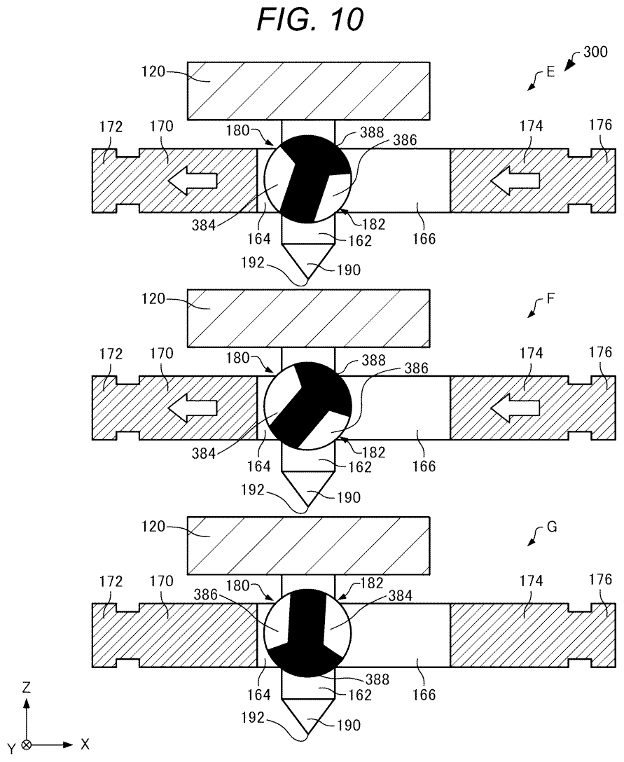

Subsequently, a three-dimensional shaping apparatus according to a second embodiment is explained with reference to the drawings. FIGS. 9 and 10 are cross-sectional views schematically illustrating a three-dimensional shaping apparatus 300 according to the second embodiment.

Hereinafter, in the three-dimensional shaping apparatus 300 according to the second embodiment, members having the same functions as the functions of the constituent members of the three-dimensional shaping apparatus 100 according to the first embodiment explained above are denoted by the same reference numerals and signs and detailed explanation of the members is omitted.

In the three-dimensional shaping apparatus 300, as illustrated in FIGS. 9 and 10, the shape of the valve 182 of the switching unit 180 is different from the shape of the valve 182 of the three-dimensional shaping apparatus 100 explained above.

A first recess 384 and a second recess 386 are formed in the valve 182 of the three-dimensional shaping apparatus 300. The first recess 384 enables communication of the first flow path 164 and the plasticizing unit 120 and enables communication of the first flow path 164 and the nozzle opening 192. The second recess 386 enables communication of the second flow path 166 and the plasticizing unit 120 and enables communication of the second flow path 166 and the nozzle opening 192.

The valve 182 includes a blocking section 388. The blocking section 388 is provided between the first recess 384 and the second recess 386 in a rotation direction of the valve 182. The blocking section 388 can block the communication path 162. In the illustrated example, the size in the X-axis direction of the blocking section 388 is larger than the size in the X-axis direction of the communication path 162.

The blocking section 388 blocks the communication path 162, whereby the switching unit 180 can set the three-dimensional shaping apparatus 300 in a communication path blocking state in which the first flow path 164 and the plasticizing unit 120 do not communicate and the second flow path 166 and the plasticizing unit 120 do not communicate. Specifically, halfway in switching the three-dimensional shaping apparatus 300 from the first state indicated by A in FIG. 9 to the second state indicated by F in FIG. 10 through B, C, D in FIG. 9 and D and E in FIG. 10, the blocking section 388 blocks the communication path 162, whereby the switching unit 180 sets the three-dimensional shaping apparatus 300 in the communication path blocking state. In the illustrated example, B, C, and D in FIG. 9 and E in FIG. 10 are the communication path blocking state.

In the three-dimensional shaping apparatus 300, halfway in switching the three-dimensional shaping apparatus 300 from the first state to the second state, the switching unit 180 sets the three-dimensional shaping apparatus 300 in a state in which the first flow path 164 and the plasticizing unit 120 do not communicate and the second flow path 166 and the plasticizing unit 120 do not communicate. For that reason, in the three-dimensional shaping apparatus 300, it is possible to prevent the plasticized material in the first flow path 164 from flowing back to the plasticizing unit 120 and it is possible to prevent the plasticized material in the second flow path 166 from flowing back to the plasticizing unit 120.

When the discharge of the plasticized material from the nozzle opening 192 is stopped, as indicated by G in FIG. 10, the switching unit 180 may set the three-dimensional shaping apparatus 300 in a state in which, with the blocking section 388 of the valve 182, the first flow path 164 and the nozzle opening 192 do not communicate and the second flow path 166 and the nozzle opening 192 do not communicate.

### 3. Third Embodiment

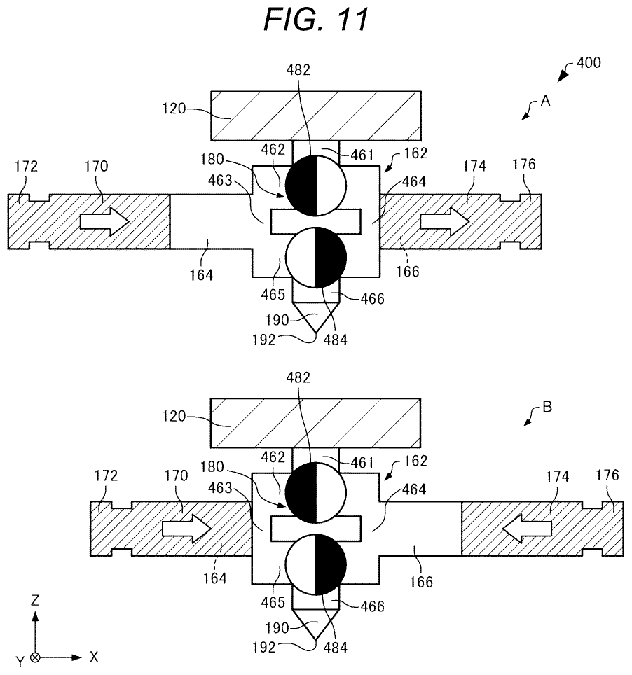

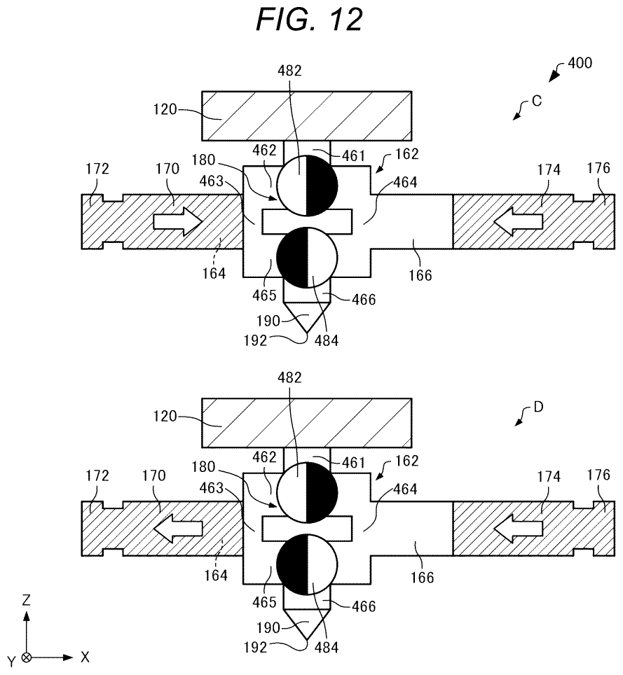

Subsequently, a three-dimensional shaping apparatus according to a third embodiment is explained with reference to the drawings. FIGS. 11 and 12 are cross-sectional views schematically illustrating a three-dimensional shaping apparatus 400 according to the third embodiment.

Hereinafter, in the three-dimensional shaping apparatus 400 according to the third embodiment, members having the same functions as the functions of the constituent members of the three-dimensional shaping apparatus 100 according to the first embodiment explained above are denoted by the same reference numerals and signs and detailed explanation of the members is omitted.

As illustrated in FIGS. 11 and 12, the three-dimensional shaping apparatus 400 is different from the three-dimensional shaping apparatus 100 explained above in that the switching unit 180 includes a first valve 482 and a second valve 484.

The first valve 482 and the second valve 484 are provided in the communication path 162. The communication path 162 includes, for example, a first path 461, a second path 462, a third path 463, a fourth path 464, a fifth path 465, and a sixth path 466.

In the illustrated example, the first path 461 is coupled to the plasticizing unit 120 and extends in the −Z-axis direction from the plasticizing unit 120. The second path 462 is coupled to the first path 461 and extends in the ±X-axis direction from the first path 461. The third path 463 is coupled to the second path 462 and extends in the −Z axis direction from one end portion of the second path 462. The fourth path 464 is coupled to the second path 462 and extends in the −Z axis direction from the other end portion of the second path 462. The fifth path 465 couples the third path 463 and the fourth path 464. The sixth path 466 extends in the −Z-axis direction from the fifth path 465 and couples the fifth path 465 and the nozzle 190.

The first valve 482 is provided at a coupling section of the first path 461 and the second path 462. The first valve 482 switches a state in which the first flow path 164 and the plasticizing unit 120 communicate and the second flow path 166 and the plasticizing unit 120 do not communicate and a state in which the second flow path 166 and the plasticizing unit 120 communicate and the first flow path 164 and the plasticizing unit 120 do not communicate.

The second valve 484 is provided at a coupling section of the fifth path 465 and the sixth path 466. The second valve 484 switches a state in which the first flow path 164 and the nozzle opening 192 communicate and the second flow path 166 and the nozzle opening 192 do not communicate and a state in which the second flow path 166 and the nozzle opening 192 communicate and the first flow path 164 and the nozzle opening 192 do not communicate.

As indicated by A and B in FIG. 11, the first state includes a state by the first valve 482 in which the second flow path 166 and the plasticizing unit 120 communicate and the first flow path 164 and the plasticizing unit 120 do not communicate and a state by the second valve 484 in which the first flow path 164 and the nozzle opening 192 communicate and the second flow path 166 and the nozzle opening 192 do not communicate.

As indicated by C and D in FIG. 12, the second state includes a state by the first valve 482 in which the first flow path 164 and the plasticizing unit 120 communicate and the second flow path 166 and the plasticizing unit 120 do not communicate and a state by the second valve 484 in which the second flow path 166 and the nozzle opening 192 communicate and the first flow path 164 and the nozzle opening 192 do not communicate.

In the three-dimensional shaping apparatus 400, the switching unit 180 includes the first valve 482 and the second valve 484 provided in the communication path 162, the first valve 482 switches a state in which the first flow path 164 and the plasticizing unit 120 communicate and the second flow path 166 and the plasticizing unit 120 do not communicate and a state in which the second flow path 166 and the plasticizing unit 120 communicate and the first flow path 164 and the plasticizing unit 120 do not communicate, and the second valve 484 switches a state in which the first flow path 164 and the nozzle opening 192 communicate and the second flow path 166 and the nozzle opening 192 do not communicate and a state in which the second flow path 166 and the nozzle opening 192 communicate and the first flow path 164 and the nozzle opening 192 do not communicate. For that reason, in the three-dimensional shaping apparatus 400, the switching unit 180 can switch the first state and the second state with the first valve 482 and the second valve 484.

### 4. Fourth Embodiment

Subsequently, a three-dimensional shaping apparatus according to a fourth embodiment is explained. Hereinafter, in the three-dimensional shaping apparatus according to the fourth embodiment, differences from the example of the three-dimensional shaping apparatus 100 according to the first embodiment explained above are explained and explanation is omitted about similarities to the example.

In the three-dimensional shaping apparatus 100 explained above, the material stored in the material storage unit 110 is the ABS resin.

On the other hand, in the three-dimensional shaping apparatus according to the fourth embodiment, the material stored in the material storage unit 110 is a material other than the ABS resin or a material obtained by adding other components to the ABS resin.

Examples of the material stored in the material storage unit 110 include materials containing various materials such as a thermoplastic material, a metal material, and a ceramic material as main materials. Here, “main material” means a material mainly forming the shape of a three-dimensional shaped object shaped by a three-dimensional shaping apparatus and means a material that accounts for a content of 50 mass % or more in the three-dimensional shaped object. The material explained above includes a material obtained by melting the main material alone and a material obtained by melting a part of components contained together with the main materials into a paste form.

As the thermoplastic material, for example, thermoplastic resin can be used. Examples of the thermoplastic resin include general-purpose plastic, general-purpose engineering plastic, and super engineering plastic.

Examples of the general-purpose plastic include polypropylene (PP), polyethylene (PE), polyvinyl chloride (PVC), and polylactic acid (PLA).

Examples of the general-purpose engineering plastic include polyacetal (POM), polyamide (PA), polycarbonate (PC), modified polyphenylene ether (m-PPE), polybutylene terephthalate (PBT), and polyethylene terephthalate (PET).

Examples of the super engineering plastic include polysulfone (PSU), polyethersulfone (PES), polyphenylene sulfide (PPS), polyarylate (PAR), polyimide (PI), polyamideimide (PAI), polyetherimide (PEI), and polyetheretherketone (peek).

Pigment, metal, and ceramic and, besides, additives such as a wax, a flame retardant, an antioxidant, and a heat stabilizer may be mixed into the thermoplastic material. In the plasticizing unit 120, the thermoplastic material is plasticized and converted into a molten state by rotation of the flat screw 130 and heating of the heating unit 150. The plasticized material generated as explained above is discharged from the nozzle 190 and deposited on the stage 20 and is thereafter cured according to a temperature drop.

In the plasticizing unit 120, for example, a metal material may be used as the main material instead of the thermoplastic material explained above. In this case, it is desirable that a powder material obtained by powdering the metal material is mixed with a component that melts when the plasticized material is generated and the mixture is fed into the plasticizing unit 120.

Examples of the metal material include single metal such as magnesium (Mg), iron (Fe), cobalt (Co), chromium (Cr), aluminum (Al), titanium (Ti), copper (Cu), and nickel (Ni) or an alloy containing one or more of these kinds of metal, maraging steel, stainless steel, cobalt chromium molybdenum, a titanium alloy, a nickel alloy, an aluminum alloy, a cobalt alloy, and a cobalt chromium alloy.

In the plasticizing unit 120, a ceramic material can be used as the main material instead of the metal materials explained above. Examples of the ceramic material include oxide ceramic such as silicon dioxide, titanium dioxide, aluminum oxide, and zirconium oxide and non-oxide ceramic such as aluminum nitride.

The powder material of the metal material or the ceramic material stored in the material storage unit 110 may be a mixed material obtained by mixing a plurality of kinds of powder of the single metal, powder of the alloy, or powder of the ceramic material. The powder material of the metal material or the ceramic material may be coated with, for example, the thermoplastic resin explained above or other thermoplastic resin. In this case, in the plasticizing unit 120, the thermoplastic resin may melt to exhibit fluidity.

For example, a solvent can also be added to the powder material of the metal material or the ceramic material stored in the material storage unit 110. Examples of the solvent include: water; (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ-picoline, and 2,6-lutidine; tetraalkylammonium acetates (for example, tetrabutylammonium acetate); and ionic liquids such as butyl carbitol acetate.

Besides, for example, a binder may be added to the powder material of the metal material or the ceramic material stored in the material storage unit 110. Examples of the binder include acrylic resin, epoxy resin, silicone resin, and cellulose-based resin, other synthetic resin, PLA, PA, PPS, and PEEK, and other thermoplastic resin.

The embodiments and the modifications explained above are examples and are not limited thereto. For example, the embodiments and the modifications can also be combined as appropriate.

The present disclosure includes substantially the same configurations as configurations explained in the embodiments, for example, configurations having the same functions, methods, and results or configurations having the same objects and effects. The present disclosure includes configurations in which unsubstantial portions of the configurations explained in the embodiments are replaced. The present disclosure includes configurations that achieve the same action effects as those of the configurations explained in the embodiments or configurations that can attain the same objects as those of the configurations explained in the embodiments. The present disclosure includes configurations obtained by adding publicly-known techniques to the configurations explained in the embodiments.

The following contents are derived from the embodiments and modifications explained above.

According to an aspect of the present disclosure, there is provided a three-dimensional shaping apparatus including:
a plasticizing unit configured to plasticize a material to generate a plasticized material;
a nozzle including a nozzle opening and configured to discharge the plasticized material from the nozzle opening;
a communication path configured to cause the plasticizing unit and the nozzle opening to communicate;
a first flow path and a second flow path coupled to the communication path;
a first plunger provided in the first flow path;
a second plunger provided in the second flow path;
a first drive unit configured to move the first plunger in the first flow path;
a second drive unit configured to move the second plunger in the second flow path;
a switching unit configured to switch a first state in which the first flow path and the nozzle opening communicate and the first flow path and the plasticizing unit do not communicate and a second state in which the second flow path and the nozzle opening communicate and the second flow path and the plasticizing unit do not communicate; and
a control unit configured to control the plasticizing unit, the first drive unit, the second drive unit, and the switching unit, wherein
after causing the first drive unit to advance the first plunger to discharge the plasticized material from the nozzle opening in the first state, the control unit causes the second drive unit to advance the second plunger to discharge the plasticized material from the nozzle opening in the second state.

With the three-dimensional shaping apparatus, it is possible to reduce the likelihood that the line width of the plasticized material discharged from the nozzle opening fluctuates.

In the three-dimensional shaping apparatus according to the aspect,
in the first state, the second flow path and the plasticizing unit may communicate and the second flow path and the nozzle opening may not communicate,
the second plunger may retreat when the first plunger is advancing in the first state,
in the second state, the first flow path and the plasticizing unit may communicate and the first flow path and the nozzle opening may not communicate, and
the first plunger may retreat when the second plunger is advancing in the second state.

With the three-dimensional shaping apparatus, it is possible to fill the second flow path with the plasticized material in the first state and fill the first flow path with the plasticized material in the second state.

In the three-dimensional shaping apparatus according to the aspect, while the three-dimensional shaping apparatus is switched from the first state to the second state by the switching unit, the first flow path may be pressurized by the first plunger and the second flow path may be pressurized by the second plunger.

With the three-dimensional shaping apparatus, it is possible to stabilize the pressure in the first flow path and the pressure in the second flow path.

In the three-dimensional shaping apparatus according to the aspect,
the switching unit may include a first valve and a second valve provided in the communication path,
the first valve may switch a state in which the first flow path and the plasticizing unit communicate and the second flow path and the plasticizing unit do not communicate and a state in which the second flow path and the plasticizing unit communicate and the first flow path and the plasticizing unit do not communicate, and
the second valve may switch a state in which the first flow path and the nozzle opening communicate and the second flow path and the nozzle opening do not communicate and a state in which the second flow path and the nozzle opening communicate and the first flow path and the nozzle opening do not communicate.

With the three-dimensional shaping apparatus, the switching unit can switch the first state and the second state with the first valve and the second valve.

In the three-dimensional shaping apparatus according to the aspect, halfway in the three-dimensional shaping apparatus being switched from the first state to the second state, the switching unit may set the three-dimensional shaping apparatus in a state in which the first flow path and the plasticizing unit do not communicate and the second flow path and the plasticizing unit do not communicate.

With the three-dimensional shaping apparatus, it is possible to prevent the plasticized material in the first flow path from flowing back to the plasticizing unit and it is possible to prevent the plasticized material in the second flow path from flowing back to the plasticizing unit.

In the three-dimensional shaping apparatus according to the aspect,
the switching unit may include a valve provided in the communication path,
the three-dimensional shaping apparatus may include an upstream valve provided in the communication path and located further upstream than the valve, and
the control unit may close the upstream valve after the plasticized material is discharged in the first state and before the three-dimensional shaping apparatus is switched from the first state to the second state.

With the three-dimensional shaping apparatus, it is possible to prevent the plasticized material in the second flow path from flowing back to the plasticizing unit.

In the three-dimensional shaping apparatus according to the aspect,
the first drive unit and the second drive unit may be motors, and
the control unit may control the first drive unit such that torque of the first drive unit is constant while the first plunger is advanced by the first drive unit and control the second drive unit such that torque of the second drive unit is constant while the second plunger is advanced by the second drive unit.

With the three-dimensional shaping apparatus, it is possible to reduce fluctuation of the pressure in the first flow path and fluctuation of the pressure in the second flow path.

In the three-dimensional shaping apparatus according to the aspect,
the first drive unit and the second drive unit may be motors, and
the control unit may control the first drive unit such that rotation speed of the first drive unit is constant while the first plunger is advanced by the first drive unit and control the second drive unit such that rotation speed of the second drive unit is constant while the second plunger is advanced by the second drive unit.

With the three-dimensional shaping apparatus, it is possible to stabilize a discharge amount of the plasticized material discharged from the nozzle opening.

According to an aspect of the present disclosure, there is provided a shaping method of shaping a shaped object using a three-dimensional shaping apparatus including:
a plasticizing unit configured to plasticize a material to generate a plasticized material;
a nozzle including a nozzle opening and configured to discharge the plasticized material from the nozzle opening;
a communication path configured to cause the plasticizing unit and the nozzle opening to communicate;
a first flow path and a second flow path coupled to the communication path;
a first plunger provided in the first flow path; a second plunger provided in the second flow path;
a first drive unit configured to move the first plunger in the first flow path;
a second drive unit configured to move the second plunger in the second flow path; and
a switching unit configured to switch a first state in which the first flow path and the nozzle opening communicate and the first flow path and the plasticizing unit do not communicate and a second state in which the second flow path and the nozzle opening communicate and the second flow path and the plasticizing unit do not communicate,
the shaping method including, after causing the first drive unit to advance the first plunger to discharge the plasticized material from the nozzle opening in the first state, causing the second drive unit to advance the second plunger to discharge the plasticized material from the nozzle opening in the second state.

With the shaping method, it is possible to reduce the likelihood that the line width of the plasticized material discharged from the nozzle opening fluctuates.

What is claimed is:

1. A three-dimensional shaping apparatus comprising:
a plasticizing unit configured to plasticize a material to generate a plasticized material;
a nozzle including a nozzle opening and configured to discharge the plasticized material from the nozzle opening;
a communication path configured to cause the plasticizing unit and the nozzle opening to communicate;
a first flow path and a second flow path coupled to the communication path;
a first plunger provided in the first flow path;
a second plunger provided in the second flow path;
a first drive unit configured to move the first plunger in the first flow path;
a second drive unit configured to move the second plunger in the second flow path;
a switching unit configured to switch a first state in which the first flow path and the nozzle opening communicate and the first flow path and the plasticizing unit do not communicate and a second state in which the second flow path and the nozzle opening communicate and the second flow path and the plasticizing unit do not communicate; and
a control unit configured to control the plasticizing unit, the first drive unit, the second drive unit, and the switching unit, wherein
after causing the first drive unit to advance the first plunger to discharge the plasticized material from the nozzle opening in the first state, the control unit causes the second drive unit to advance the second plunger to discharge the plasticized material from the nozzle opening in the second state.

2. The three-dimensional shaping apparatus according to claim 1, wherein
in the first state, the second flow path and the plasticizing unit communicate and the second flow path and the nozzle opening do not communicate,
the second plunger retreats when the first plunger is advancing in the first state,
in the second state, the first flow path and the plasticizing unit communicate and the first flow path and the nozzle opening do not communicate, and
the first plunger retreats when the second plunger is advancing in the second state.

3. The three-dimensional shaping apparatus according to claim 1, wherein, while the three-dimensional shaping apparatus is switched from the first state to the second state by the switching unit, the first flow path is pressurized by the first plunger and the second flow path is pressurized by the second plunger.

4. The three-dimensional shaping apparatus according to claim 1, wherein
the switching unit includes a first valve and a second valve provided in the communication path,
the first valve switches a state in which the first flow path and the plasticizing unit communicate and the second flow path and the plasticizing unit do not communicate and a state in which the second flow path and the plasticizing unit communicate and the first flow path and the plasticizing unit do not communicate, and
the second valve switches a state in which the first flow path and the nozzle opening communicate and the second flow path and the nozzle opening do not communicate and a state in which the second flow path and the nozzle opening communicate and the first flow path and the nozzle opening do not communicate.

5. The three-dimensional shaping apparatus according to claim 1, wherein, halfway in the three-dimensional shaping apparatus being switched from the first state to the second state, the switching unit sets the three-dimensional shaping apparatus in a state in which the first flow path and the plasticizing unit do not communicate and the second flow path and the plasticizing unit do not communicate.

6. The three-dimensional shaping apparatus according to claim 3, wherein
the switching unit includes a valve provided in the communication path,
the three-dimensional shaping apparatus comprises an upstream valve provided in the communication path and located further upstream than the valve, and
the control unit closes the upstream valve after the plasticized material is discharged in the first state and before the three-dimensional shaping apparatus is switched from the first state to the second state.

7. The three-dimensional shaping apparatus according to claim 1, wherein
the first drive unit and the second drive unit are motors, and
the control unit controls the first drive unit such that torque of the first drive unit is constant while the first plunger is advanced by the first drive unit and controls the second drive unit such that torque of the second drive unit is constant while the second plunger is advanced by the second drive unit.

8. The three-dimensional shaping apparatus according to claim 1, wherein
the first drive unit and the second drive unit are motors, and
the control unit controls the first drive unit such that rotation speed of the first drive unit is constant while the first plunger is advanced by the first drive unit and controls the second drive unit such that rotation speed of the second drive unit is constant while the second plunger is advanced by the second drive unit.

9. A shaping method of shaping a shaped object using a three-dimensional shaping apparatus including:
a plasticizing unit configured to plasticize a material to generate a plasticized material;
a nozzle including a nozzle opening and configured to discharge the plasticized material from the nozzle opening;
a communication path configured to cause the plasticizing unit and the nozzle opening to communicate;
a first flow path and a second flow path coupled to the communication path;
a first plunger provided in the first flow path;
a second plunger provided in the second flow path;
a first drive unit configured to move the first plunger in the first flow path;
a second drive unit configured to move the second plunger in the second flow path; and
a switching unit configured to switch a first state in which the first flow path and the nozzle opening communicate and the first flow path and the plasticizing unit do not communicate and a second state in which the second flow path and the nozzle opening communicate and the second flow path and the plasticizing unit do not communicate,
the shaping method comprising, after causing the first drive unit to advance the first plunger to discharge the plasticized material from the nozzle opening in the first state, causing the second drive unit to advance the second plunger to discharge the plasticized material from the nozzle opening in the second state.
